(19) United States
(12) Patent Application Publication
(10) Pub. No.: US 2018/0154429 A1
(43) Pub. Date: Jun. 7, 2018

(54) METHOD FOR CASTING A TURBINE BLADE

(71) Applicant: SIEMENS AKTIENGESELLSCHAFT, München (DE)

(72) Inventors: KHALED MAIZ, BERLIN (DE); MARTIN WILLIAMS, DUNSTON (GB)

(21) Appl. No.: 15/575,396

(22) PCT Filed: May 2, 2016
(86) PCT No.: PCT/EP2016/059761

§ 371 Date: Nov. 20, 2017

(30) Foreign Application Priority Data
May 26, 2015 (DE) 10 2015 209 587.8

(51) Int. Cl. B22C 21/14; B22C 9/10; F01D 5/18

(52) U.S. Cl. CPC B22C 21/14; B22C 9/103; B22C 9/108; F05D 2260/201; F05D 2240/301; F05D 2230/21; F01D 5/187

(57) ABSTRACT

Provided is a method for casting a turbine blade including a blade root, a blade extending in the radial direction from the blade root, and a hollow chamber that passes through the turbine blade in the radial direction from the blade root up to the free end of the blade, wherein the method is carried out using a casting molding defining an outer surface of the turbine blade and using a core accommodated in the casting mold and aligned with positioning means, wherein at least one second core is accommodated in the molding part and aligned with positioning means, wherein the first core and the second core are spaced at a distance from one another and behind one another in the radial direction in the casting mold in such a way that a gap is formed between said cores.

### CROSS-REFERENCE TO RELATED APPLICATIONS

This application claims priority to PCT Application No. PCT/EP2016/059761, having a filing date of May 2, 2016, based on German Application No. 10 2015 209 587.8, having a filing date of May 26, 2015, the entire contents both of which are hereby incorporated by reference.

### FIELD OF TECHNOLOGY

The following relates to a method for casting a turbine blade having a blade root, a blade airfoil extending in the radial direction from the blade root and a cavity which passes through the turbine blade in the radial direction from the blade root to the free end of the blade airfoil, wherein the method is carried out using a casting mold defining an outer surface of the turbine blade and using a core that is received in the casting mold and is oriented with positioning means. The following also relates to a turbine blade having a blade root, a blade airfoil extending in the radial direction from the blade root and a cavity which passes through the turbine blade in the radial direction from the blade root to the free end of the blade airfoil.

### BACKGROUND

Methods of this kind for casting a turbine blade are known in a number of different forms in the prior art and serve for the production of turbine blades, in particular for gas turbines. In such gas turbines, the flow energy of expanding hot gas is converted into rotational energy by means of turbine blades. To that end, a gas turbine comprises for example a turbine casing through which passes a turbine shaft, a turbine held rotationally fixed on the turbine shaft and having a plurality of radially extending turbine blades, and a combustion chamber in which hot gas is generated by burning a fuel mixed with compressed air. From the combustion chamber, the hot gas is guided via connecting pipes into the turbine, where it expands and flows through the turbine blades. Upstream of the turbine, a compressor which draws in and compresses ambient air is held rotationally fixed on the turbine shaft. Part of the compressed air is routed into the combustion chamber, and the other part of the compressed air is used for cooling the turbine.

During operation of a gas turbine, the turbine blades are subjected to large thermal and mechanical loads as a consequence of the high temperature of the hot gas and the high rotational speed of the turbine shaft, which is commonly between 3000 and 3600 revolutions per minute (rpm), but can also be much higher, in a range between 10,000 and 15,000 rpm, in the case of appropriate output-side reduction gearing. Although solid rotor blades offer high mechanical strength, they limit the maximum permissible temperature of the hot gas flowing through the turbine, and thus the efficiency of the gas turbine.

In order to increase the thermal loads to which a turbine blade can be subjected, a cooling fluid can be made to flow through the turbine blade. In a turbine blade cooled in this manner, there is formed at least one cavity which passes through the turbine blade in the radial direction and through which the cooling fluid flows. The cooling fluid heated in the turbine blade leaves the turbine blade via corresponding cooling fluid outlet openings and flows, together with the expanded hot gas, through an exhaust duct and out of the gas turbine.

In order to increase the efficiency of a gas turbine, it is desirable to increase the length of the turbine blades. Solid turbine blades are subject to almost no limits in terms of production since they can be produced solely by chip-removing machining of the exterior of a blank. By contrast, cooled turbine blades through which at least one cavity passes in the radial direction can generally be produced only by casting, owing to their complex shape. To that end, at least one core for creating the at least one cavity is positioned in a casting mold that defines the outer surface of the turbine blade. This core is oriented in the casting mold using positioning means in order to set the required wall thickness of the turbine blade. Then, the interspace remaining between the casting mold and the core is filled with heated, liquid casting material. In that context, the core, which is commonly made of a ceramic material, is subject to considerable heating by the casting material, which leads to deformation and/or displacement of the core in the casting mold during casting. Deformation of the core occurs predominantly as a radial expansion. Owing to the twisted shape of the turbine blade, this expansion can lead to undesired deviations from the predetermined wall thicknesses. In addition, the internal stresses generated by the high-temperature can also cause the core to fracture. Furthermore, with ceramic cores the risk of breakage during general handling increases with increasing length.

Owing to these problems that originate predominantly with the core, hollow turbine blades cannot be made just with any length, which limits the efficiency that can be achieved with a gas turbine that is provided with cooled turbine blades.

### SUMMARY

An aspect relates to a method for casting a turbine blade of the type mentioned in the introduction, with which it is possible to produce long turbine blades.

The problem according to embodiments of the invention is achieved for a method for casting a turbine blade in that at least one second core is received in the casting mold and is oriented with positioning means, wherein the first core and the second core are arranged one behind the other in the radial direction and are spaced apart from one another in the casting mold such that a gap is formed between these cores.

Thus, embodiments of the invention are based on the consideration that the use of two smaller cores instead of one large single core facilitates production and handling of the cores and also reduces their respective deformation and/or displacement during casting, thus on one hand reducing the risk of breakage and on the other hand counteracting undesired deviation from the required wall thickness of the turbine blade.

According to one embodiment of the method, each core comprises multiple core sections that extend in the radial direction and are arranged next to and spaced apart from one another, which sections are connected to one another by means of connecting pins. Cores of this type make it possible to create, in a turbine blade, multiple cavities that lie next one another transversely to the radial direction and are separate from one another.

Preferably, the gap extends essentially transversely to the radial direction. Having the gap extend in this manner makes it possible for each core to expand in the radial direction without producing a compressive stress in the cores that could cause the cores to break. The longitudinal expansion of the cores then leads merely to a constriction of the gap which can however be disregarded when configuring the cores.

Advantageously, the size of the gap decreases in particular evenly inward from the casting mold. In other words, the gap narrows with increasing distance from the casting mold, such that in side view the gap is in the shape of two wedges pointing toward one another. The configuration of the gap can be used to take into account that the deformation and/or displacement of the cores transversely to the radial direction can be different.

Preferably, guide pins extend between the first core and the second core, which pins are received in corresponding bores of the first core and of the second core so as to be displaceable in their longitudinal direction, wherein the guide pins extend preferably parallel to one another and/or in the radial direction. Guide pins of that type permit specific relative orientation of the two cores and also ensure that this relative orientation is maintained even in the event of the cores expanding during casting. In addition, the guide pins can create connecting openings in a rib, of the turbine blade, created in the gap in order to connect to one another the cavities created by the cores.

In a development of the method according to embodiments of the invention, spacer pins, which extend between the first core and the casting mold and/or between the second core and the casting mold, are used as positioning means, wherein at least some of the spacer pins are preferably arranged adjacent to the gap. Spacer pins that are affixed to the cores and bear against the casting mold from the inside make it easy to set the distance between the cores and the casting mold. Spacer pins arranged adjacent to the gap make it possible to orient the two cores relative to one another and relative to the casting mold.

Alternatively or in addition, as positioning means, use is made of at least one tongue which is designed in one piece with the first or the second core and projects outward therefrom in the direction of the casting mold, in particular is arranged in the region of the free end of the blade airfoil or in the region of the blade root and extends in the radial direction. A tongue of this type has the advantage that it can be made in one piece with the core. Tongues of this type are suitable for immobilizing the cores in opposite end regions of the casting mold.

Preferably, the at least one tongue is received in the casting mold and is in engagement therewith. A tongue of this kind creates corresponding openings in the wall of the cast piece, which can serve as inlet or outlet openings for a cooling fluid.

Advantageously, the at least one tongue has a recess extending transversely to the radial direction and/or a projection extending transversely to the radial direction. Recesses or projections on the tongue in the region where it engages with the casting mold prevent the core from moving in the radial direction. As a consequence, the longitudinal expansion of the core caused by contact with the hot casting material acts only in the direction of the gap, and hence the deformation remains easily controllable.

In one variant of the method according to embodiments of the invention, connecting openings between a cavity created by the first core and a cavity created by the second core are bored, after casting, in a rib created by the gap. Since the rib represents a partition that extends transversely to the radial direction of the turbine blade, it must be provided with connecting openings in order to connect to one another the cavities created with the cores, such that the cooling fluid can flow through the entire turbine blade.

Furthermore, embodiments of the present invention provide a turbine blade of the type mentioned in the introduction, of which the cavity is divided by at least one rib which extends transversely to the radial direction and is provided with connecting openings, wherein the rib is in particular arranged in a central region of the turbine blade, with regard to the radial direction. Choosing a suitable length ratio of the cores makes it possible to determine the position of the rib in the turbine blade in the radial direction such that the stiffness of the turbine blade is increased and its natural vibration during operation of the gas turbine is substantially damped. Natural vibrations of the turbine blade can cause a fault in the gas turbine and shorten its service life.

A turbine blade according to the invention can have a length of at least 70 cm, more advantageously of at least 80 cm and preferably of at least 100 cm. The longer the turbine blade, the greater the possible efficiency of the corresponding gas turbine.

### BRIEF DESCRIPTION

Some of the embodiments will be described in detail, with references to the following figures, wherein like designations denote like members, wherein:

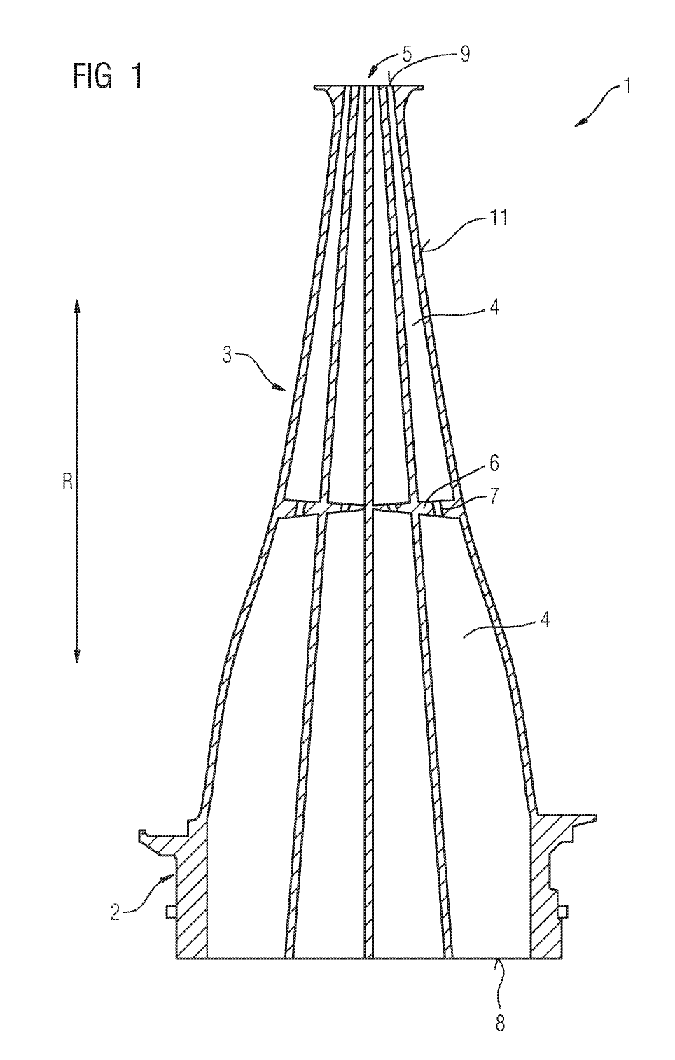

FIG. 1 is a side cross-sectional view of a turbine blade according to one embodiment of the present invention, which has been produced using a method according to one embodiment of the present invention;

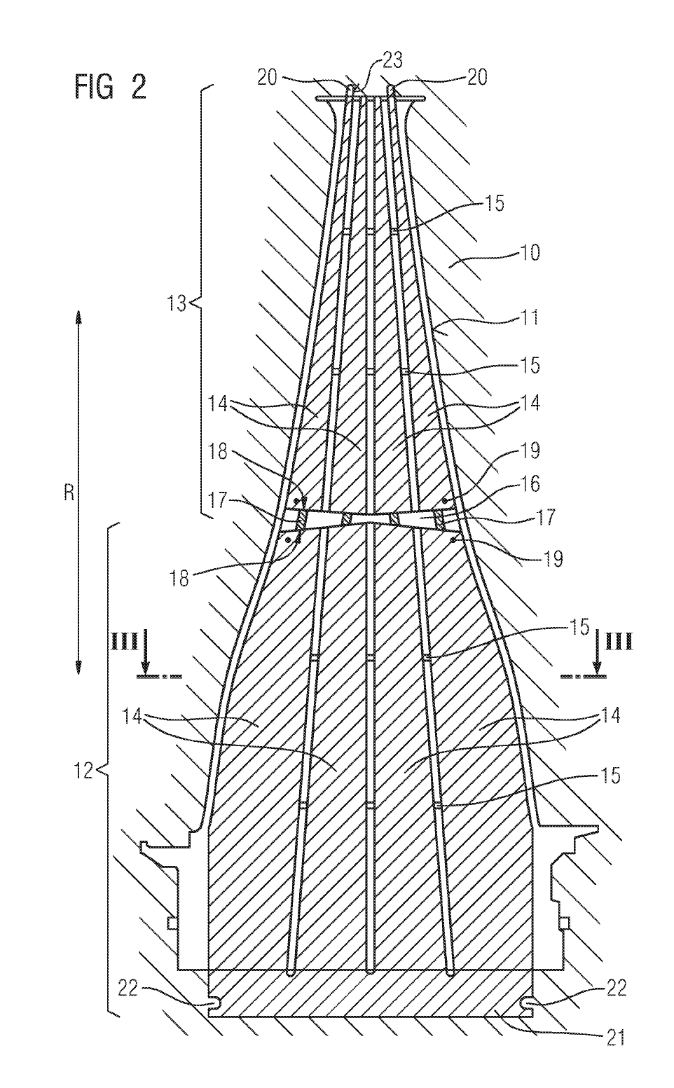

FIG. 2 is a side cross-sectional view of two cores arranged in a casting mold for the purpose of producing the turbine blade shown in FIG. 1; and

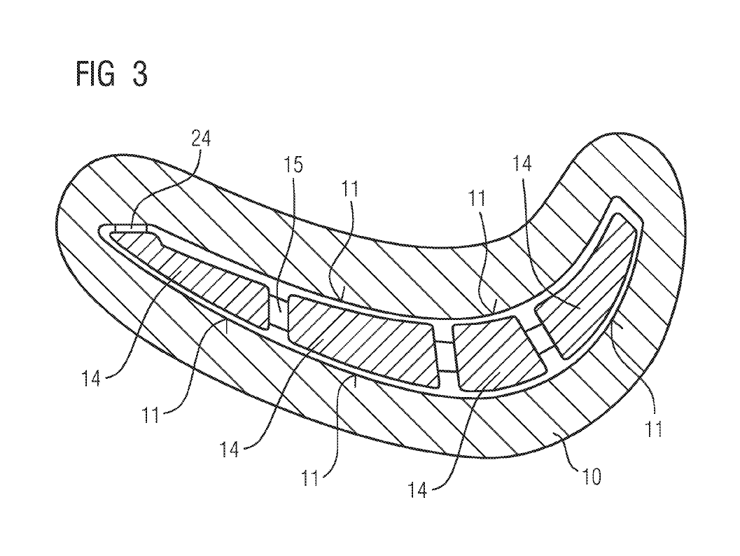

FIG. 3 is a radial cross-sectional view of the first core which is shown in FIG. 2 and is arranged in a casting mold, along the line III-III.

### DETAILED DESCRIPTION

FIG. 1 shows a turbine blade 1 for a gas turbine, which has been produced using a method according to embodiments of the present invention. The turbine blade 1 comprises a blade root 2 and a blade airfoil 3 that extends in the radial direction R from the blade root 2. The turbine blade 1 has an overall length in the radial direction of at least 70 cm, but can advantageously be at least 80 cm and preferably at least 100 cm long. In the present case, four cavities 4, which each pass through the turbine blade 1 in the radial direction from the blade root 2 to a free end 5 of the blade airfoil 3, extend through the turbine blade 1, where the number of cavities 4 can vary. The cavities 4 are divided by a rib 6 which extends transversely to the radial direction R and is arranged in a central region of the turbine blade 1, with regard to the radial direction. Accordingly, four connecting openings 7 are provided in the rib 6 and connect mutually aligned cavities 4 on either side of the rib 6. Four inlet openings 8 are formed at the blade root 2, and four outlet openings 9 are provided at the free end 5 of the blade airfoil 3.

During operation of the gas turbine, a cooling fluid flows radially outward through the inlet openings 8 in to the turbine blade 1 and through the cavities 4 created by the first core 12, the connecting openings 7 and the cavities created by the second core 13 to the free end 5 of the blade airfoil 3. The cooling fluid then leaves the turbine blade 1 through the outlet openings 9, and thus the heat absorbed by the cooling fluid is removed from the turbine blade 1.

FIGS. 2 and 3 show a casting mold 10 which is used for the production of the turbine blade 1 and which defines an outer surface 11 of the turbine blade 1. The casting mold 10 receives a first core 12 and a second core 13 that are arranged one behind the other in the radial direction and are spaced apart from one another in the casting mold 10. Each core comprises multiple core sections 14 that extend in the radial direction R and are arranged next to and spaced apart from one another transversely to the radial direction R. The core sections 14 of a core 12, 13 are respectively connected to one another by means of connecting pins 15. A gap 16 extending essentially transversely to the radial direction is formed between the first core 12 and the second core 13. The size of the gap 16 decreases evenly inward from the casting mold 10, such that in a side cross-sectional view the gap is essentially in the shape of two wedges pointing toward one another. The shape of the gap 16 depends on the shape of the turbine blade and expected deformations and/or displacements of the cores 12, 13, and can vary. Guide pins 17 extend between the first core 12 and the second core 13, which pins are received in corresponding bores 18 of the first core 12 and of the second core 13 so as to be displaceable in their longitudinal direction, wherein the guide pins 17 extend parallel to one another in the radial direction R.

The first core 12 and the second core 13 are oriented in the casting mold 10 with positioning means 19, 20, 21. Spacer pins 19, which extend between the first core 12 and the casting mold 10 and/or between the second core 13 and the casting mold 10, are used as positioning means. In that context, some of the spacer pins 19 are arranged adjacent to the gap 16. As further positioning means, a tongue 20 is designed in one piece with the first core 12 in the region of the blade root 2 and extends in the radial direction. As further positioning means, two tongues 21 that are integral with the second core 13 project outward therefrom in the direction of the casting mold 10 from the free end 5 of the blade airfoil 3, and extend in the radial direction. The tongues 20, 21 are received in the casting mold 10 and are in engagement therewith. The tongue 20 has two recesses 22 that extend transversely to the radial direction R and are arranged on opposite sides of the tongue 20. The two tongues 21 each have a projection 23 extending transversely to the radial direction. In order to fix the two cores 12, 13 in the radial direction, the tongues 20, 21 can also have undercuts in addition to recesses 22 or projections 23. Optionally, further outlet openings can be provided by casting on the trailing edge side of the turbine blade 1, using appropriately positioned opening pins 24 that extend between the cores 12, 13 and the casting mold 10. Alternatively, such outlet openings can also be formed afterwards by mechanical machining such as drilling.

During casting, the interspaces formed between the cores 12, 13 and the casting mold 10, or between the respective core sections 14, are filled with a heated, liquid casting material. In the process, the core sections 14 of the first core 12 and of the second core 13 are heated by the casting material and expand also in the radial direction. The longitudinal expansion of the first core 12 or of the second core 13 causes a constriction of the gap 16 since the core sections 14 of the first core 12 are held radially securely in the casting mold 10 in the region of the blade root 2 and the tongues 21 of the second core 13 are held radially securely in the region of the free end 5 of the blade airfoil 3. In the case of a twisted turbine blade 1, the different longitudinal expansion (owing to the different longitudinal extent) of the cores 12, 13 means that the gap 16 narrows more in the lateral edge regions of the turbine blade 1 than in the middle. As a result, this leads to a flattening of the wedge shape of the gap 16 and thus of the rib 6 of the turbine blade 1, which is evident when comparing FIGS. 1 and 2. The change in the size of the gap 16 during casting depends on the shape of the turbine blade 1 and of the cores 12, 13, and can vary.

The guide pins 17 create connecting openings 7 which connect mutually aligned cavities 4 on either side of the rib 6 formed by the casting material that has solidified in the gap 16, and through which the cooling fluid can flow from the cavities created by the first core 12 into the cavities created by the second core 13. If, by contrast, no guide pins 17 are used, the rib 6 separates the cavities 4 created by the first core 12 and by the second core 13 in the manner of a partition, so that a cooling fluid would not be able to flow through the turbine blade 1. In this variant, connecting openings 7 are therefore introduced subsequently into the rib 6 by drilling, in order to interconnect mutually aligned cavities 4 created by the first core 12 and by the second core 13.

One advantage of the method according to embodiments of the invention is that, when using two cores 12, 13, each core 12, 13 is shorter, which on one hand facilitates production and handling of the core and on the other hand reduces its longitudinal expansion. This makes it possible to reliably cast longer turbine blades 1 through which pass cavities 4 that extend from the blade root 2 to the free end 5 of the blade airfoil 3. Thus, the method according to embodiments of the invention makes it possible to produce long turbine blades 1 that can be cooled effectively. This permits a high temperature of the hot gas, which is associated with high efficiency of the gas turbine. In addition, the rib 6 that is formed in the gap 16 in the method according to embodiments of the invention can substantially damp the natural vibration of the turbine blade 1, and avoid a fault in the gas turbine.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for casting a turbine blade having a blade root, a blade airfoil extending in a radial direction from the blade root, and a cavity which passes through the turbine blade in the radial direction from the blade root to a free end of the blade airfoil, the method comprising:
utilizing a casting mold defining an outer surface of the turbine blade and a first core that is received in the casting mold and is oriented with a positioning means;
wherein at least one second core is received in the casting mold and is oriented with the positioning means,
wherein the first core and the second core are arranged one behind the other in the radial direction and are spaced apart from one another in the casting mold such that a gap is formed between the first core and the second core.

2. The method as claimed in claim 1, wherein the first core and the second core each comprise multiple core sections that extend in the radial direction and are arranged next to and spaced apart from one another, the multiple core sections being connected to one another by means of connecting pins.

3. The method as claimed in claim 1, wherein the gap extends essentially transversely to the radial direction.

4. The method as claimed in claim 3, wherein a size of the gap decreases evenly inward from the casting mold.

5. The method as claimed in claim 1, wherein guide pins extend between the first core and the second core, the guide pins being received in corresponding bores of the first core and of the second core so as to be displaceable in their longitudinal direction,
further wherein the guide pins extend parallel to one another and/or in the radial direction.

6. The method as claimed in claim 1, wherein spacer pins, which extend between the first core and the casting mold and/or between the second core and the casting mold), are used as the positioning means,
further wherein at least some of the spacer pins are arranged adjacent to the gap.

7. The method as claimed in claim 1, wherein as positioning means, use is made of at least one tongue which is designed in one piece with the first core or the second core and projects outward therefrom in a direction of the casting mold, is arranged in a region of the free end of the blade airfoil or in a region of the blade root and extends in the radial direction.

8. The method as claimed in claim 7, wherein the at least one tongue is received in the casting mold and is in engagement therewith.

9. The method as claimed in either of claim 7, wherein the at least one tongue has a recess extending transversely to the radial direction and/or a projection extending transversely to the radial direction.

10. The method as claimed in claim 1, wherein after casting, connecting openings between a cavity created by the first core and a cavity created by the second core are bored in a rib created by the gap.

11. A turbine blade having a blade root, a blade airfoil extending in a radial direction from the blade root and a cavity which passes through the turbine blade in the radial direction from the blade root to a free end of the blade airfoil, wherein the cavity is divided by at least one rib which extends transversely to the radial direction and is provided with connecting openings, wherein the rib is arranged in a central region of the turbine blade, with regard to the radial direction.

12. The turbine blade as claimed in claim 11, wherein the turbine blade has a length of at least one of: at least 70 cm, at least 80 cm, and at least 100 cm.
